(19) United States
(12) Patent Application Publication
(10) Pub. No.: US 2015/0229884 A1
(43) Pub. Date: Aug. 13, 2015

(54) SYSTEMS AND METHODS CONCERNING INTEGRATED VIDEO SURVEILLANCE OF REMOTE ASSETS

(71) Applicant: ABB Technology AG, Zurich (CH)

(72) Inventors: Ronald A. Kupiec, Chagrin Falls, OH (US); Martin Hermes, Cleveland Heights, OH (US); Lynn Roy Tanner, Twinsburg, OH (US)

(21) Appl. No.: 14/616,427

(22) Filed: Feb. 6, 2015

Related U.S. Application Data
(60) Provisional application No. 61/937,005, filed on Feb. 7, 2014.

(51) Int. Cl. H04N 7/18; G08B 21/18; G08B 25/00

(52) U.S. Cl. CPC H04N 7/18; G08B 25/00; G08B 21/18

(57) ABSTRACT

A distributed control system and associated methods of operating distributed control systems includes an asset management system including an asset monitor, event system and alarm system. The management system is operable to communicate with one or more remote stations disposed proximate to one or more assets. The remote stations include camera configured to detect events specific to the particular assets, and upon detecting the event, storing pre-event cached images and post-event images in the asset management system in directories specific to the assets at which the event was recorded.

### FIELD OF INVENTION

This disclosure concerns distributed control system management and visual observation of system assets.

### BACKGROUND

Systems having one or more assets that can benefit from visual observation can also pose challenges in implementing observation of the assets. In many cases, the assets are unmanned and are spread over large geographic area, thus increasing the burden of travel between assets. Even if service personnel inspect the assets, the assets can be difficult to access for service personnel. Permanent manning or monitoring of video feeds of the assets can prove cost-prohibitive from a human resource standpoint, and impractical as the assets are not visually interesting. Requiring operators of distributed control systems to spend time monitoring video surveillance systems separate from the asset management system can result in inefficiencies as the operator can split attention between an asset management system and separate video surveillance equipment. Even if constant live video were desirable, live streaming would negatively impact already limited bandwidth of networks, and be constrained by the same bandwidth limitations. In addition, the assets can be managed from multiple asset management centers.

It is therefore beneficial to have a low cost visual monitoring system for geographically distant assets, permitting operator access to live video of the remote site but without the requirement for constant human observation of the stream. It is also therefore beneficial to have a visual monitoring system that requires minimal bandwidth. It is further beneficial to consolidate video surveillance with asset management systems from the perspective of the operator to provide access to video information in the context of the asset management system.

### SUMMARY OF THE INVENTION

Systems and methods for implementing integrated video surveillance allow visual monitoring of assets that are part of a distributed operations or control system. The information from the video source, which can for example be stored as image or video files, is integrated as an additional input among other asset parameters of the particular asset. Video events are detected by a camera that stores images both prior to the event, which images are accessible in a cache when the event is detected, and after event detection. Images are transferred only upon occurrence of an event.

This systems and methods described herein allows the integration of video based alarms with existing operation alarms, allowing video based and other operational based alarms to be managed in a similar manner. The systems described herein permit an operator to have a more complete understanding of the operating condition of assets being managed. Operators are notified of visual events without continuous monitoring of video feeds from multiple assets. Consolidation of visual alarms with other operational and process alarms allows for faster diagnosis of asset conditions. The systems and methods described herein can be extended to include audio triggering and storage and monitoring of perimeter security triggers with the video surveillance system.

### BRIEF DESCRIPTION OF THE DRAWINGS

In the accompanying drawings, structures and methods are illustrated that, together with the detailed description provided below, describe aspects of a system for integrated video surveillance of remote assets, and related methods. It will be noted that a single component may be implemented as multiple components or that multiple components may be implemented as a single component. The figures are not drawn to scale and the proportions of certain parts have been exaggerated for convenience of illustration. Further, in the accompanying drawings and description that follow, like parts are indicated throughout the drawings and written description with the same reference numerals, respectively.

FIG. 1 illustrates a diagram of distributed control system 100.

FIG. 2 illustrates a diagram of camera 104 and asset management system 120.

FIG. 3 illustrates a process flow for operating a distributed control system 100.

FIG. 4 illustrates an asset status window 400.

### DETAILED DESCRIPTION

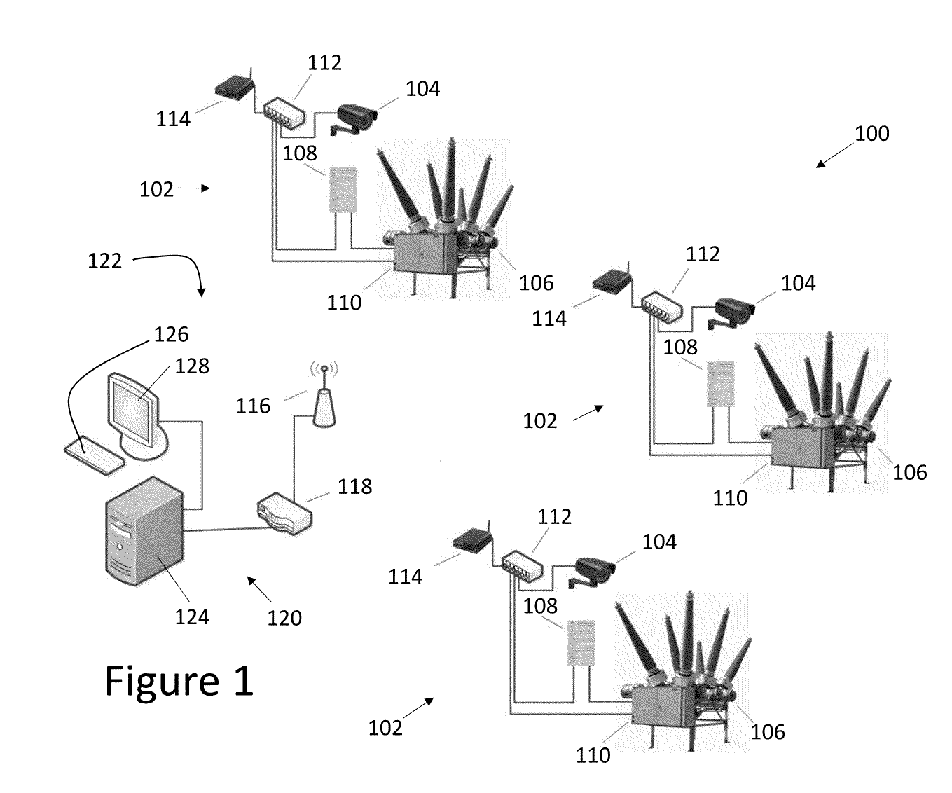

With reference to FIG. 1, distributed control system 100 includes remote stations 102 including cameras 104 disposed at remote assets 106, such as the illustrated transformers. Assets 106 need not be limited to transformers, but can include without limitation breakers, reclosers, relays, other power generation or distribution assets, or any other form of remote asset 106. Cameras 104 can be selectively placed at any desirable location relative to assets 106. For example, cameras 104 can be video cameras selectively placed such that critical aspects of the remote assets 106 can be captured within the field of view of the cameras 104. Remote stations 102 can include a variety of monitoring equipment in addition to cameras 104. For example, monitoring of a transformer asset 106 can include implementing sensors that provide temperature information, oil gas information, hot spot detection, acoustic information, and other forms of data.

The remote station 102 includes a remote monitoring device 108 which can be operatively coupled to the remote asset 106, to sensors installed at the remote asset 106 to detect operating parameters of the asset 106, or to the asset control unit 110. The asset control unit 110 includes instrumentation and controls for the assets 106. The remote monitoring device 108 can be incorporated into the asset control unit 110, or can be a separate device, for example as when retrofitting assets 106 to include remote monitoring devices 108. The cameras 104, remote monitoring devices 108, and asset control unit 110 are connected to a network hub 112. The hub 112 permits communication between the devices connected to the hub 112 and between the devices and a network modem 114. The modems 114 communicates with an operations center receiver 116, which is connected to an asset management system 120 through a network gateway 118. The receiver 116, gateway 118 and asset management system 120 can be located at an operations center 122 that is geographically remote from the assets 106. The asset management system 120 can include a server or computer 124, user interface 126 and display 128.

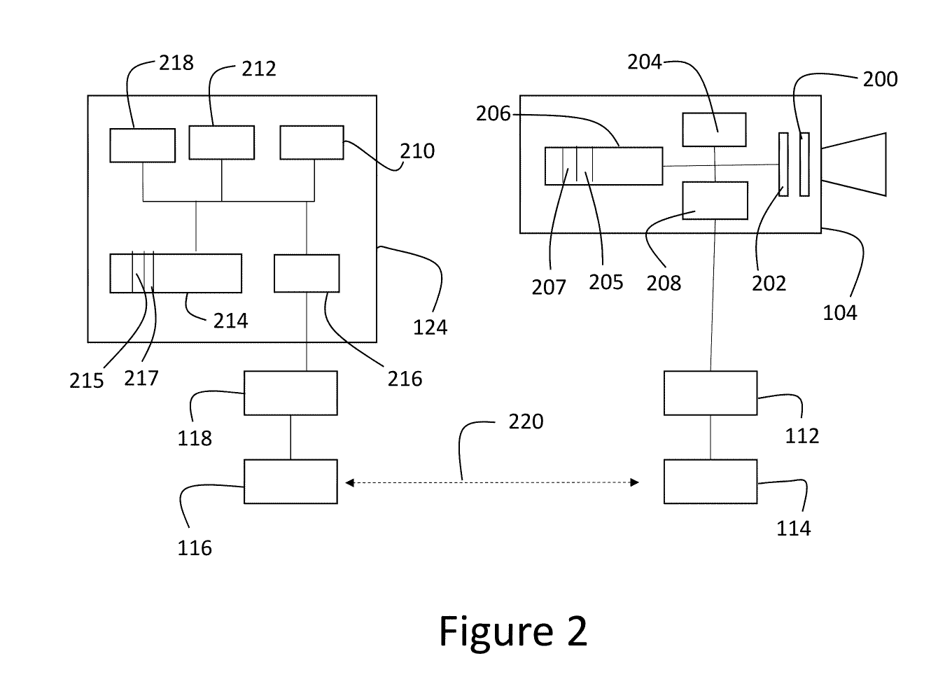

With reference to FIG. 2, the camera 104 includes a lens 200, and an image sensor 202 coupled to an image processor 204. The image processor 204 can process the signals received by the image sensor 202 into a digital image file 205 that can be stored on a non-transient computer-readable medium 206. Computer-readable medium 206 also can include instructions 207 that can be executed by image processor 204. A network adapter 208 allows the camera 104 to communicate with hub 112. Computer 124 includes processor 210, non-transient computer readable memory 212 and storage 214, network adapter 216 and video processor 218. The storage 214 can include instructions 215 and image files 217, including but not limited to image files transferred from camera 104 over wireless connection 220. It should be noted that computer-executable instructions can be stored on one or both of memory, such as random access memory, or storage such as hard disk drives.

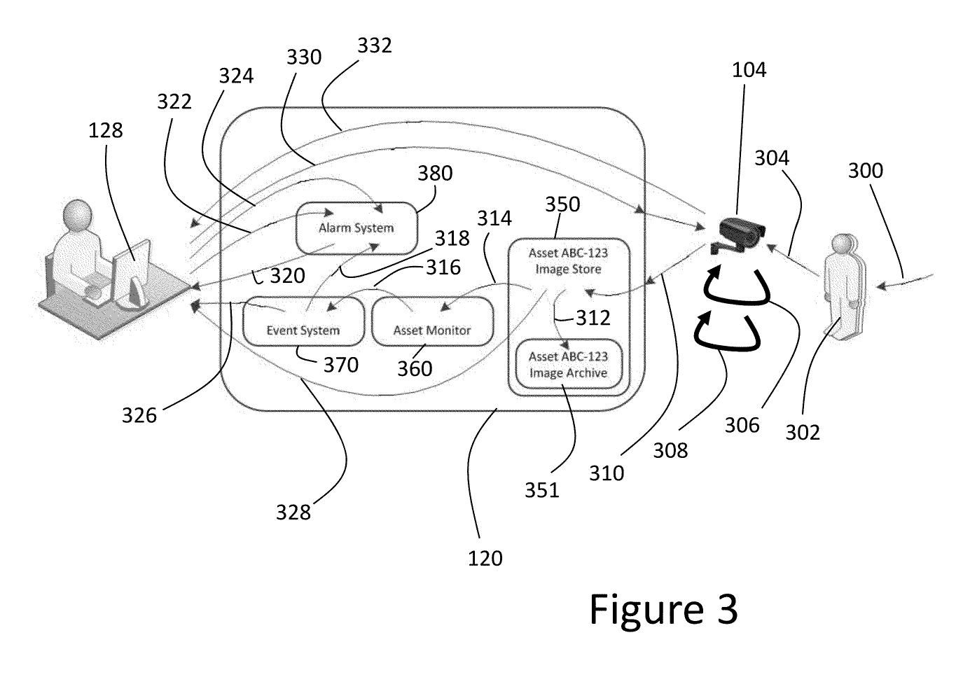

With reference to FIG. 3, in step 300 an unauthorized person 302 enters the field of view of camera 104. In step 304, the camera 104 detects the event, which in the illustrated case corresponds to an unauthorized person 302 entering the field of view of the camera 104. While access of an unauthorized individual corresponds to the illustrated event, events can also be triggered, for example, by wildlife, severe weather and physical damage. The camera 104 can make the determination that an event has occurred if predetermined image parameters are met, such as detection of image changes based on performing pixel change analysis of images with image processor 204. The camera 104 can also detect events through a variety of alternative methods, including but not limited to by positioning motion detectors to detect motion in spaces corresponding to the camera's field of view, or security alarms that trigger upon authorized entry to area corresponding to camera's field of view. In addition to the foregoing, camera 104 can be alerted to events by non-visual triggers such as alarms triggered by the remote monitoring device 108 or asset control unit 110. In step 306, upon detection of the event by camera 104, the camera 104 stores pre-event images in a buffer, for example as image or video files in non-transient computer readable medium 206. In step 308, the camera 104 collects and stores post-event images, for example in non-transient computer readable medium 206. The duration of time over which post-event image data is collected by camera 104 can be limited to a predetermined duration or can continue indefinitely.

With continued reference to FIG. 3, in step 310, the camera 104 stores the pre-event images and post-event images on the asset management system 120, for example on non-transient computer-readable storage 214. According to one aspect of the present disclosure, the image files are stored in directories 350 or image stores, located on non-transient computer-readable media such as storage 214, specific to assets 106. In step 312, the image files are also copied to image archives 351 in directories specific to the assets 106. According to one aspect, an asset monitor 360 stores the images for preceding events in the image archive 351, leaving the images for the current event in the asset-specific image store 350.

In step 314, the asset monitor 360, which can be executed by processor based on non-transient computer readable instruction, detects storage of new images stored in an asset-specific directory on asset management system 120. In step 316, the asset monitor 360 issues an event notification to the event system 370, which manages and provides user access to information concerning events including but not limited to events triggering camera 104 to store event images such as in step 304. In step 318, the event system 370 sends an alarm notification to the alarm system 380. In step 320, the alarm system 380 displays a user message to operator, for example on display 128. In step 322, the user acknowledges the alarm message and in step 324, the user selects the alarm details. In step 326, upon user selection of alarm details, the event system 370 displays the operating conditions of the particular asset 106 and images corresponding to the event stored in the asset-specific directory 350. In step 328, the user can select a live video feed from the camera 104, which can prompt the asset management system 120 to connect to the camera 104 in step 330. In step 332, the camera 104 streams a real time video feed based upon the user selection. Both the event notification provided to event system 370 in step 316, and the alarm notification provided to alarm system 380 in step 318 provide the location of the image or video files. According to one aspect of the present teachings, this includes providing the asset-specific directory the images or videos are located. In one aspect of the present disclosure, the alarm message includes an alarm details link that upon selection by the operator displays event details and asset 106 operating parameters. The asset monitor 360, event system 370, alarm system 380 and other systems can be software instructions stored on a non-transient computer readable medium such as storage 214 and running on a processor such as processor 210.

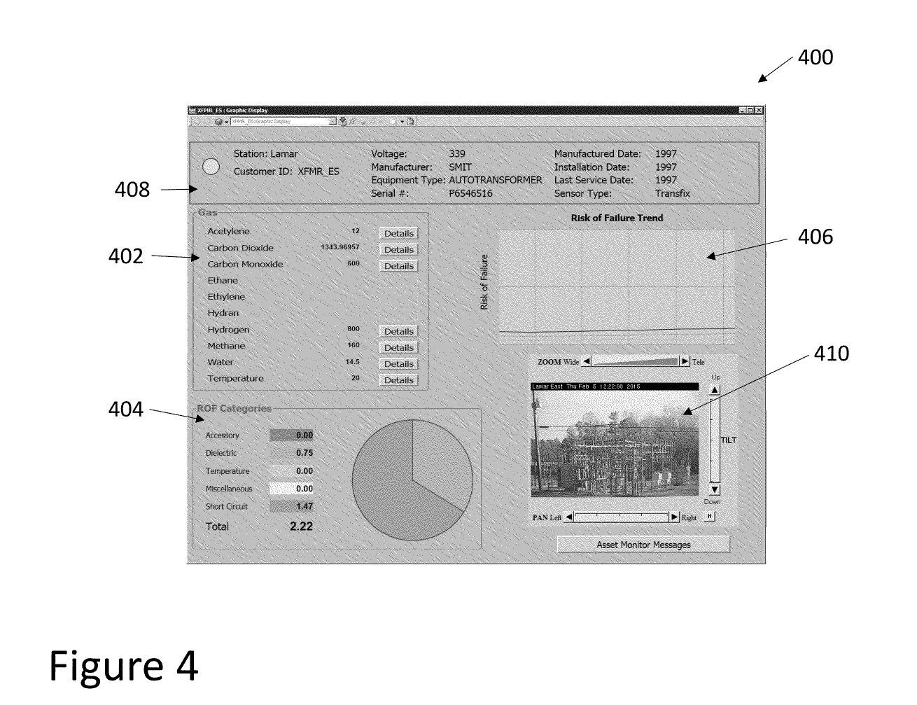

The alarm system 380 and event system 370 are both configured to provide the user access to images associated with a triggering event such as in step 304. For example, the alarm message can include a selectable button or link that opens an asset status window 400 such as shown in FIG. 4. The asset status window 400 includes several graphical elements that display information concerning an asset 106, such as a graphical element showing gas content 402, rate of failure categories 404, failure trend 406, asset identification information 408, and image display 410. The image display 410 shows the images stored in the asset-specific directory, and optionally provides a selectable button or link that upon user selection opens a live video feed from the camera 106. The images or video can be selectively displayed or manipulated in the same ways in which standard video or images files of the same file type can be displayed or manipulated.

In the present disclosure, reference numerals followed by alphabetic indices refer to one of the illustrated elements, while use of the reference numeral without the alphabetic indices refer to one or more of the illustrated elements. For the purposes of this disclosure and unless otherwise specified, “a” or “an” means “one or more.” To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. From about A to B is intended to mean from about A to about B, where A and B are the specified values.

The description of various embodiments and the details of those embodiments is illustrative and is not intended to restrict or in any way limit the scope of the claimed invention to those embodiments and details. Additional advantages and modifications will be apparent to those skilled in the art. Therefore, the invention, in its broader aspects, is not limited to the specific details and illustrative examples shown and described. Accordingly, departures may be made from such details without departing from the spirit or scope of the applicant's claimed invention.

1. A distributed control system, comprising:
an asset management system including a user interface, asset monitor, event system and alarm system, and operable to communicate with one or more remote stations disposed proximate to one or more assets;
the one or more remote stations including a camera configured to detect events specific to one of the one or more assets and upon detection of an event based on predetermined image parameters, store pre-event cached images and store post-event images in the asset management system in one or more directories each specific to the one of the one or more assets;
the asset monitor configured to detect storage of images by the camera in the directories specific to the assets and upon detection of storage of images send an event notification to the event system, the event system configured to send an alarm notification to the alarm system upon receipt of the event notification, the alarm system configured to send a user alarm message to the user interface.

2. The system of claim 1, wherein the alarm system is configured to selectively display the images stored in the directory upon user interaction with the alarm message.

3. The system of claim 1, wherein the event system is configured to selectively display the images stored in the directory upon user interaction with an event detail link in an alarm message.

4. The system of claim 1, wherein the asset management system is configured to accept a command from an operator to open a live video stream from the camera upon sending an event notification to the event system.

5. A method of operating a distributed system, comprising:
detecting an event with a camera disposed proximate to a remote asset, based on video images obtained from the camera;
upon detection of the event, storing pre-event cached images and post-event images in an asset management system in a directory specific the asset;
detecting stored images in the directory with an image file asset monitor and upon detection of stored images issuing an event notification to the event system; and,
upon receiving the event notification, the event system displaying an event detail on a graphic user interface including the stored pre-event and post-event images.

6. The method of claim 5, wherein the event system issues an alarm notification to an alarm system upon receiving the event notification, and the alarm system issuing an alarm message to a user interface upon receiving the alarm notification.
